(19) United States
(12) Patent Application Publication
(10) Pub. No.: US 2004/0004555 A1
(43) Pub. Date: Jan. 8, 2004

(54) Field selectable communication network

(75) Inventor: Brent Martin, Walhalla, SC (US)

Correspondence Address: DORITY & MANNING, P.A., POST OFFICE BOX 1449, GREENVILLE, SC, 29602-1449, US

(73) Assignee: SchlumbergerSema Inc.

(21) Appl. No.: 10/190,316

(22) Filed: Jul. 3, 2002

(51) Int. Cl. G08C 15/06; G08B 23/00

(52) U.S. Cl. 340/870.02

(57) ABSTRACT

A utility meter and corresponding communication board comprises an installation channel, a processor, software selection lines, and at least one network interface element. Types of communication networks with which a utility meter is to be interfaced are inputted as information through an installation channel such as a modem, optical port, or other communication channel. This information is processed and software selection lines are provided to respective network interface elements. Each programmed network interface element can be configured to connect to a selected one of existing standard networks RS232, RS485, RS422 or other communication network. Since a single communication board in accordance with the disclosed technology interfaces with a variety of communication networks, a more efficient and cost effective network selection and implementation mechanism is provided.

### BACKGROUND OF THE INVENTION

The present subject matter generally concerns a system for selecting a communication network for utility meters, and more particularly, a communication board and corresponding utility meter that enables the type of communication network with which a utility meter is interfaced to be selected in the field (i.e., after its manufacture). The subject utility meter and communication board for use therewith enables a single meter communication board to be used with a variety of different utility meters and corresponding communication networks.

Several types of customer utilities are available at residential and commercial properties worldwide. Such properties and other locations may typically be supplied with selected utilities (i.e., products, or commodities) such as water, gas, electricity, cable service, telecommunications, and others. When a selected utility is provided to a customer load, there is typically some sort of metering mechanism, e.g., hardware, that is available for monitoring the amount of product that is provided to a specific customer load or otherwise consumed. Utility meters are typically characterized by some sort of metrology device that measures this consumption information and provides other desired information about the utility.

Many utility meters also include communications elements that provide, among other features, a signal interface between the meter itself and other devices in a utility network. Such devices may include other meters, peripheral computer systems, intermediate network nodes, and/or network controller systems. The type of communication network that interfaces a meter with other devices in a utility system often varies depending on the specific utility type and metering application. Three main communication networks that are typically used among various devices and nodes in a utility system are RS232, RS485 and RS422 networks. Each of these communication networks corresponds to a different type of transmission specification. More particularly, each network is defined with different voltage levels for indicating digital language protocols (i.e. 1's and 0's) among electronic devices in a utility system.

Many utility applications are configured in accordance with only one of many standard communication networks (such as RS232, RS485, RS422, etc.) Thus, each utility meter in a particular application must be outfitted with a communication board that is compatible with the communication network for that application. This has typically meant that a utility company must match a specific communication board and utility meter with a given utility application and corresponding computer network. This matching process often involves tracking a meter (and corresponding communication board) from the time of order until delivery to the installation site in order to ensure proper installation and operation. If the wrong meter is ordered or delivered or if a communication network was misidentified then additional time and money must be spent to correct the oversight. Another service visit must typically be scheduled, and another potential interruption of user power will occur.

Some utility meters are provided with a known type of communication board that can be selected to interface with different communication networks. For instance, some meter communication boards are provided with manual jumpers that can be physically reconfigured to route communication signals from the meter either to a device that supports only RS232 communication or to another device that supports RS422/RS485 communication.

While providing a degree of advantage, meters and communication boards outfitted with this type of jumper-selecting communication network option may still have drawbacks as solutions for selecting a type of meter communication network. Such jumpers are typically activated by manual manipulation, and thus safety issues are prevalent. A meter must be properly powered down and removed from the meter socket or other installation location in order to manipulate a jumper in a safe and appropriate fashion.

It is thus desired to provide improved features and methods for selecting the type of communication network with which a utility meter and corresponding communication board are to be interfaced. While various systems and arrangements have been developed to address meter communication network selection, no one design has emerged that generally encompasses all of the desired characteristics as hereafter presented in accordance with the subject technology.

### BRIEF SUMMARY OF THE INVENTION

In view of the discussed drawbacks and shortcomings encountered in the field of utility metering, an improved system for selecting the type of communication network with which a meter is to be interfaced has been developed. Thus, broadly speaking, a general object of the present subject matter is to provide a communication board with a software selection feature to establish the type of communication network with which the communication board and corresponding utility meter is interfaced.

It is another principal object of the present subject matter to provide a single communication board and corresponding utility meter that can be interfaced with a plurality of different communication networks, including RS232, RS485 and RS422 networks. The ability to provide a single component that replaces multiple others thus yields a more efficient mechanism for selecting types of meter communication networks.

It is yet another principal object of the disclosed technology to provide a communication board that can be programmed in the field during installation or subsequently. Such a communication board in accordance with the disclosed technology offers reduced installation time and thus a more expedient solution since the potential for faulty network selection is minimized. Such aspect also provides for fewer potential interruptions of a customer's utility service.

It is another object of the present subject matter to provide a communication board and corresponding utility meter whose communication network type can be readily selected and easily changed or upgraded. This versatility also enables a single meter communication board to be readily interchangeable with other meters and different utility applications.

It is yet another object of the subject system to provide a meter communication network selection option implemented via software features. Such software solution is typically much more inexpensive than existing hardware-based alternatives. A software solution is also safer since it avoids the need to open a meter and manually handle selection jumpers or other hardware components.

A still further object of the present subject matter is that a communication board and corresponding utility meter in accordance with the disclosed technology typically reduces the amount of initial knowledge, especially with regards to communication network configurations, that must be provided by a utility when ordering replacement utility meters and new installations.

Additional objects and advantages of the present subject matter are set forth in, or will be apparent to, those of ordinary skill in the art from the detailed description herein. Also, it should be further appreciated that modifications and variations to the specifically illustrated, referred and discussed features and steps hereof may be practiced in various embodiments and uses of the subject technology without departing from the spirit and scope thereof, by virtue of present reference thereto. Such variations may include, but are not limited to, substitution of equivalent means, features, or steps for those illustrated, referenced, or discussed, and the functional, operational, or positional reversal of various parts, features, steps, or the like.

Still further, it is to be understood that different embodiments, as well as different presently preferred embodiments, of this technology may include various combinations or configurations of presently disclosed features or elements, or their equivalents (including combinations of features, parts, or steps or configurations thereof not expressly shown in the figures or stated in the detailed description of such figures). One exemplary such embodiment of the present subject matter relates to a communication board for use in a utility meter. The communication board is interfaced with at least one external communication network and comprises a processor, at least one network interface element, and selection lines provided from the processor to each network interface element.

More preferably, software features implemented in the processor are responsive to input at an installation channel such as an optical port, modem, or other communication channel. Signals representative of the installation channel inputs are provided at the selection lines to each network interface element in order to establish the type of signaling protocol and corresponding communication network with which each respective network interface element is to communicate. Certain exemplary embodiments are provided with two network interface elements and corresponding network selection features.

Another present exemplary embodiment of the subject technology concerns a utility meter for monitoring the distribution of a utility product, wherein the utility is provided in conjunction with at least one external communication network. The utility meter preferably comprises at least two circuit boards, including one circuit board that encompasses the main electronics and metrology hardware and another that encompasses selected communications features of the meter. The communications board further comprises a processor, at least one communication network interface element and a software selection feature for establishing the type of communication network for each interface element. An installation input channel may also be provided for receiving input information designating the type of communication networks that are desired for a particular utility application.

Additional embodiments of the present subject matter, not necessarily expressed in this summarized section, may include and incorporate various combinations of aspects of features, components, or steps referenced in the summarized objectives above, and/or other features, components, or steps as otherwise discussed in this application. Those of ordinary skill in the art will better appreciate the features and aspects of such embodiments, and others, upon review of the remainder of the specification.

### BRIEF DESCRIPTION OF THE DRAWINGS

A full and enabling disclosure of the present subject matter, including the best mode thereof, directed to one of ordinary skill in the art, is set forth in the specification, which makes reference to the appended figures, in which:

FIG. 1 is a diagram illustration of an exemplary communication network among utility meters and other exemplary devices within a utility system; and

FIG. 2 is a block diagram of a utility meter and corresponding communication board in accordance with the disclosed technology for interfacing with selected communication networks within a utility system.

Repeat use of reference characters throughout the present specification and appended drawings is intended to represent same or analogous features or elements of the invention.

### DETAILED DESCRIPTION OF THE EMBODIMENTS

As previously discussed, the present subject matter is particularly concerned with a system for selecting a communication network for utility meters, and more particularly, a communication board and corresponding utility meter that enables the type of communication network with which a utility meter is interfaced to be selected in the field. The subject utility meter and communication board for use therewith enables the use of a single meter communication board with a variety of different utility meters and communication networks.

It should be noted that each of the exemplary embodiments presented and discussed herein should not insinuate limitations of the present subject matter. Features illustrated or described as part of one embodiment may be used in combination with aspects of another embodiment to yield yet further embodiments. Additionally, certain features may be interchanged with similar devices or features not expressly mentioned which perform the same or similar function. Reference will now be made in detail to the presently preferred embodiments of the subject interactive utility system.

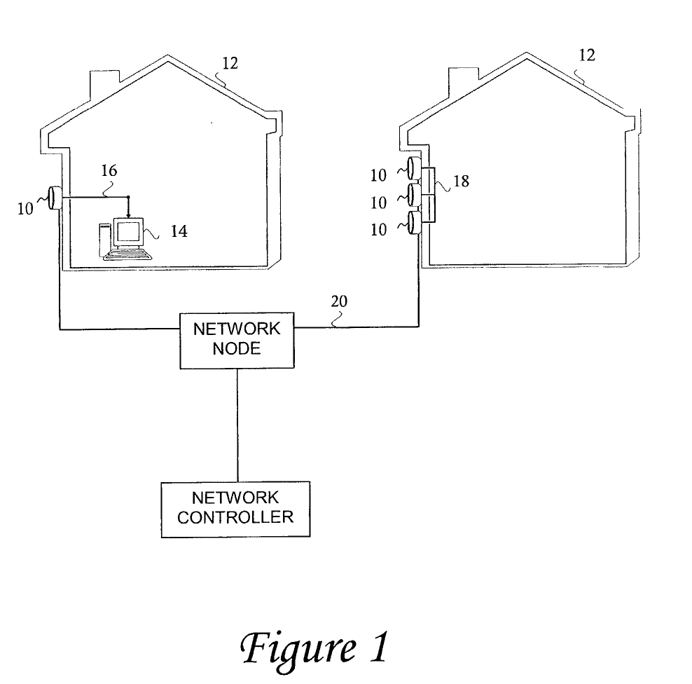

Referring now to the drawings, FIG. 1 provides a diagrammatic illustration of aspects of communication networks in the context of a utility system. Utility meters 10 are provided at various end locations 12 to monitor the distribution of a utility product or service. Exemplary utility products and services include, but are not limited to, electrical energy, water, gas, cable service, telecommunications services, and others. Each utility meter preferably communicates in some way with other devices within its utility system. For instance, it may be desired that a utility meter 10 communicate directly or indirectly with other utility meters, with a computer or energy management console 14, with a central network controller, and/or with some intermediate network node between a meter and a network controller module.

Communication among utility meters and other devices in a utility system can be implemented in a variety of fashions, including hardwire communication networks and/or wireless communication networks. The present subject matter addresses aspects of hardwire communication networks among utility system devices. However, it should be appreciated that the present subject matter can be utilized in combination with additional communication systems and methods such as wireless networks.

The type of hardwire communication network that is established among given nodes in a utility system may vary depending on the type of node and given application, and/or due to changes and/or advances in aspects of such network technology. Typical communication network types utilized in a utility system include RS232, RS485 and RS422. Each respective communication network corresponds to different voltage levels that are relayed to represent the logical 1's and 0's of a digital signal.

Exemplary communication network and interface 16 between a utility meter 10 and peripheral computer system 14 may correspond in certain embodiments to an RS232 communication network. In certain instances, such network provides an appropriate interface for controlling aspects of a specific utility meter, including energy management and service connection control. Exemplary communication network and interface 18 among utility meters 10 may correspond in certain embodiments to an RS485 communication network. In certain instances, such network provides an appropriate interface that allows two or more utility meters to be connected to a local area network (LAN) or other central communications device within a building or complex.

Although certain communication networks may be desired over others in certain applications, the communication networks with which a utility meter and or other devices are connected, including exemplary networks 16, 18 and 20 of FIG. 1, may correspond to a variety of network protocols, including RS232, RS485 and/or RS422. The present subject matter provides features that facilitate the selection of the different communication networks with which a utility meter is to be interfaced. Although the disclosed technology is presented in accordance with selection features for a utility meter, it should be appreciated that similar features may be incorporated with other devices in a utility system, including peripheral computer systems, network controllers, and intermediate network nodes, and still remain within the spirit and scope of the present subject matter.

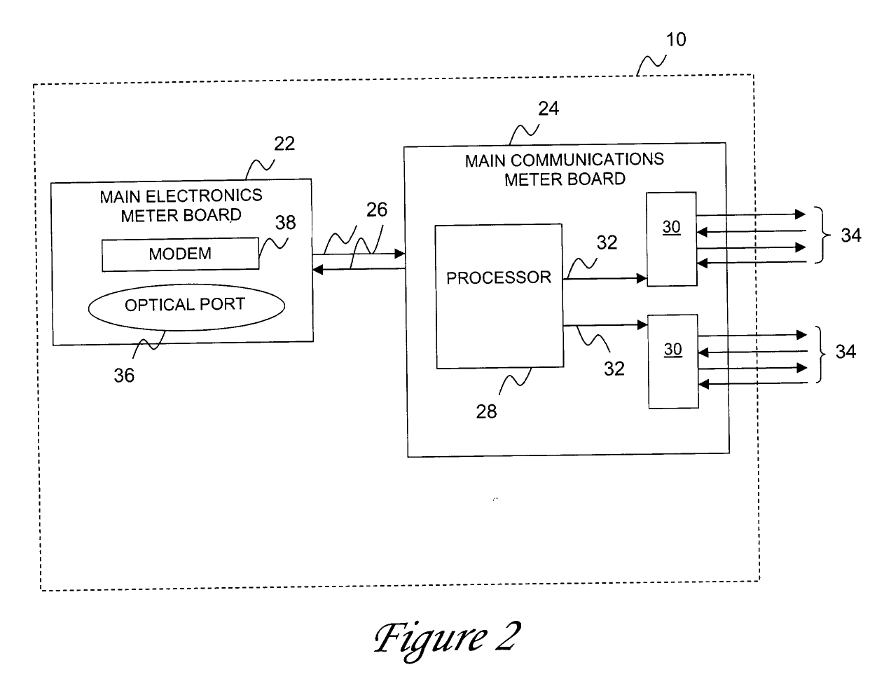

With further reference to the exemplary embodiments of the disclosed technology, FIG. 2 provides a block diagram of a utility meter and corresponding communication board in accordance with the disclosed technology for interfacing with selected communication networks within a utility system. A utility meter includes many electronic components, and often includes a plurality of circuit boards. The exemplary utility meter 10 of FIG. 2 includes a main electronics meter board 22 and a main communications meter board 24. Alternatively, for some embodiments, board 24 may be implemented in a manner physically external to meter 10 and used therewith, as opposed to being situated internally to meter 10. Each meter board 22 is intended to provide different functionality for utility meter 10, and such functionality may readily vary with different meters and metering applications. Specific features and methodology associated with such functionality are well known to one of ordinary skill in the art, and details thereof form no particular aspect of the disclosed technology and thus is not specifically discussed.

Electronics board 22 preferably provides basic metrology circuitry associated with monitoring utility distribution and providing utility information based thereon. Electronics board 22 and selected components thereof are preferably in electrical communication with communication board 24 via internal communication link 26. The communication board preferably includes features for providing selected external communication routes by which utility meter 10 can communicate with other utility system devices. Communication board 24 preferably includes elements such as processor 28 and network interface elements 30. Software selection lines 32 are provided from processor 28 to each network interface element 30.

The meter is programmed via software to select the type of communication network 34 that each network interface element 30 will be connected to. The actual software instruction to carry out the desired selection process should be well within the purview of one of ordinary skill in the art and is thus not presently provided in greater detail. As understood to one of ordinary skill in the art, the specific design of specialized code to implement such selection typically depends on the type of internal components and external interfacing utilized in each utility meter and corresponding environment.

The type selection of communication network 34 to which each network interface element 30 is connected can be effected in the field by authorized service personnel. This selection may also by done by wireless transmission to a utility meter from an appropriate signal source. For example, a utility meter is often provided with an optical data port 36 and/or a modem 38. Input information corresponding to the type of desired communication network(s) can be provided to utility meter 10 through an installation channel such as optical port 36, modem 36 or some other existing communication channel.

Input information can be provided for a new meter installation, a change in meter application, or an upgrade to existing service. Each time communication networks are selected at a utility meter, only one service interruption will typically be required. The risk of installing the wrong type of communication board should no longer pose a problem, since every communication board in accordance with the present subject matter can be readily programmed to connect to a variety of different communication networks. Although existing communication networks may preferably correspond to RS232, RS485 and RS422 standardized networks, the present technology should also apply to other networks and/or additional new communication networks as they are developed.

Once input information is provided to utility meter 10 through optical port 36, modem 38, or other installation channel, internal communication link 26 relays such information to communications board 24. Processor 28 generates network control signals to pass over software selection lines 32 that instruct each network interface element 30 of which communication network type 34 it is to interface with. An appropriate interface for at least one communication network is thus established. The subject system and features thereof are more efficient, expedient, inexpensive and safe than other posed solutions to network type selection.

While the present subject matter has been described in detail with respect to specific embodiments thereof, it will be appreciated that those skilled in the art, upon attaining an understanding of the foregoing may readily produce alterations to, variations of, and equivalents to such embodiments. Accordingly, the scope of the present disclosure is by way of example rather than by way of limitation, and the subject disclosure does not preclude inclusion of such modifications, variations and/or additions to the present subject matter as would be readily apparent to one of ordinary skill in the art.

What is claimed is:

1. A utility meter for monitoring the distribution of a utility product or service, wherein said utility meter is interfaced with selected communication networks, said utility meter comprising:
a main electronics meter board for providing basic metrology circuitry associated with monitoring utility distribution and providing utility information based thereon;
a main communication board for providing interfacing elements to properly relay selected of said utility information, said main communication board comprising:
(i) a processor;
(ii) at least one communication network interface element;
(iii) software selection lines for establishing an external communication network type to which each communication network interface element is provided;
an installation channel provided in conjunction with said main electronics meter board for receiving input information designating the type of communication network to be established over said software selection lines; and
an internal communication link for relaying information between said main electronics meter board and said main communication board.

2. A utility meter for monitoring the distribution of a utility product or service as in claim 1, wherein the distributed utility product comprises electrical energy.

3. A utility meter for monitoring the distribution of a utility product or service as in claim 1, wherein each communication network type is selected from the group consisting of RS232, RS485, and RS422.

4. A utility meter for monitoring the distribution of a utility product or service as in claim 1, wherein said installation channel includes an optical port.

5. A utility meter for monitoring the distribution of a utility product or service as in claim 1, wherein said installation channel includes a modem.

6. A communication board for use with a utility meter, wherein the communication board is interfaced with at least one external communication network, said communication board comprising:
a processor for processing selected information communicated internally within the utility meter and communicated externally among the meter and other devices over a communications network;
at least one network interface element for connecting to an external communication network; and
selection lines provided from said processor to each said network interface element for relaying software selection information indicative of the type of communication network with which each network interface element is to operate.

7. A communication board for use with a utility meter as in claim 6, wherein said communication board is in electrical communication with a main electronic circuit board and wherein the main electronic circuit board provides basic metrology circuitry associated with monitoring utility distribution.

8. A communication board for use with a utility meter as in claim 6, wherein said processor is responsive to input information provided to an installation channel by authorized personnel in the field.

9. A communication board for use with a utility meter as in claim 8, wherein said installation channel includes an optical port.

10. A communication board for use with a utility meter as in claim 9, wherein each communication network type is selected from the group consisting of RS232, RS485, and RS422.

11. A communication board for use with a utility meter as in claim 8, wherein said installation channel includes a modem.

12. A communication board for use with a utility meter as in claim 6, wherein said communication board comprises two network interface elements.

13. A communication board for use with a utility meter as in claim 6, wherein the utility meter is employed to monitor the distribution of electrical energy.

14. A communication board for use with a utility meter as in claim 6, wherein each communication network type is selected from the group consisting of RS232, RS485, and RS422.

15. A communication board for use with a utility meter as in claim 6, wherein said communication board is included in a utility meter.
